(19) United States
(12) Patent Application Publication
(10) Pub. No.: US 2014/0067609 A1
(43) Pub. Date: Mar. 6, 2014

(54) ONLINE EXCHANGE FOR 3-D PRINTABLE PRODUCTS

(71) Applicant: Chad Buege Heger, Foothill Ranch, CA (US)

(72) Inventor: Chad Buege Heger, Foothill Ranch, CA (US)

(21) Appl. No.: 13/828,068

(22) Filed: Mar. 14, 2013

Related U.S. Application Data
(60) Provisional application No. 61/695,929, filed on Aug. 31, 2012.

(51) Int. Cl. G06Q 30/06

(52) U.S. Cl. CPC G06Q 30/0623
USPC 705/26.61; 705/28; 705/310; 705/26.1

(57) ABSTRACT

A method and system for eliminating storage and transportation of products within a product distribution system is disclosed saving money and time since businesses do not need to have products shipped and stored. The method and system includes an online store through which designers can upload electronic files of printable products and consumers can view the printable products for purchase, download and printing on a 3D printer. The method and system also allows for implementation of protection systems for designers with the option of insuring the final design is not tampered with by anyone other than the designer.

### CROSS-REFERENCE TO RELATED APPLICATIONS

This application claims the benefit of U.S. provisional patent application Ser. No. 61/695,929, filed on Aug. 31, 2012, the entire contents of which is expressly incorporated herein by reference.

### STATEMENT RE: FEDERALLY SPONSORED RESEARCH/DEVELOPMENT

Not Applicable

### BACKGROUND

The present invention relates to a new method of obtaining products without shipping.

In the life cycle of a product, the product begins as an idea by a company. The company may engineer the product and outsource manufacturing of the product or manufacture the product themselves. The country of manufacture may be in country or out of country depending on the market conditions, costs to ship and timing requirements. After manufacturing, the product is shipped to the company or a distributor for further storage and shipment when a retailer orders the product. If the manufactured product is imported or crosses jurisdictional boundaries, there may be a tax or tariff. The manufactured products are shipped to one or more distributors until a wholesaler orders the manufactured products. The distributor ships the product to the wholesaler who must also maintain inventor until ordered by a retailer. The retailer orders the manufactured products and displays everything on the retail floor with a small inventory in stock. The consumer purchases the products and stores the product at home, if a consumable product. Throughout the entire distribution process, the product is stored and shipped which takes time, space and work to transport the product from one location to another. Moreover, the shipping of the products from one location to another adds to the carbon footprint of the product.

Accordingly, there is a need in the art for an improved product distribution model.

### BRIEF SUMMARY

The product distribution model and its various aspects discussed herein address the deficiencies described above, described below and those that are known in the art.

The product distribution model described herein relate to distributing product electronically for consumers to print with a 3-D printer so as to eliminate most if not all of the shipping and storage costs involved in the prior art distribution model. To this end, the product distribution model discussed herein contemplates a public or private electronic exchange platform through which designers can upload printable products to an online store and consumers can view, select and download electronic files from the online store. The consumer prints the product on one or more 3-D printers capable of printing a variety of materials. This distribution model eliminates storage and transportation of physical products along the chain from the manufacturer to the consumer. The implication of this model is that consumers do not need to wait for product to be shipped and transported to the consumer. The consumer can enjoy the product by printing the product on his/her 3D printer or having a local retail establishment print the product. Businesses do not need to stock items for use but can print products when needed. This reduces cash required for inventory. This reduces shipping costs. This reduces lead time. The business stores only raw materials that can be used to print a variety of products. Machinery can be fixed by printing a broken part. Parts that normally do not break do not need to be manufactured and stored just in case that someone might need the rare part. Rather, the electronic files allow the business to print any one of a plurality of parts for replacement.

More particularly, a method for facilitating exchange of electronic files of three-dimensional printable products is disclosed. The method may comprise the steps of receiving at least one electronic file from each of a plurality of suppliers of electronic files of three-dimensional printable products; displaying the three-dimensional printable products to consumers of the three-dimensional printable products; receiving selections of the displayed three-dimensional printable products from consumers; and transmitting the corresponding electronic files of the received selection of three-dimensional printable products to the consumers.

The method may further comprise the step of transmitting instruction sets to the consumers for the received selections of three-dimensional printable products.

The three-dimensional printable products may be smaller or larger than 1′×1′×1′.

The transmitting step may comprise the step of transmitting to one of the consumers a plurality of electronic files which after being printed may be assembled to make up the three-dimensional printable products.

The three-dimensional printable products may be displayed by category to the consumer.

The method may further comprise the step of displaying a rank of the printable product in relation to at least one of quality of electronic files, past consumer ranking, compatible raw materials, and compatible 3D printers to the consumer.

In another aspect, a just-in-time inventory control method is disclosed. The method may comprise the steps of tracking inventory for a plurality of three-dimensional printable products; and printing one or more three-dimensional printable products when the tracking step indicates a low quantity of the one or more three-dimensional printable products.

The method may further comprise the step of accessing an online store of electronic files of three-dimensional printable products.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic diagram of a new product distribution model; and

FIG. 2 is a schematic diagram of a process for printing a three dimensional printable product.

### DETAILED DESCRIPTION

Referring now to the drawings, a method for receiving products immediately without having to wait for shipping and transit of product is disclosed. The method connects the designer and the end user or consumer so that the consumer can use products designed by the designer quickly without having to go through the traditional shipping and storing at the various levels of the distribution chain. The method utilizes an electronic exchange platform 10 through which designers 12 can upload electronic files of three-dimensional printable products for purchase and consumers 14 can download the electronic files for printing. This bypasses the manufacturing step, importing step, the distributing step, the wholesaling step and the retailing step. For example, a consumer 14 of a product may view an online store 10 of products (e.g. cups, spoons, forks, paperclips, tape dispenser, etc.) on an online store 10. The consumer 14 may select a product from the online store 10. Instead of having the product manufactured, imported to a distributor and shipped from the distribution source to the consumer 14, the consumer 14 may download one or more electronic files of the product which are used to print the product on a three-dimensional printer 16. In this manner, the consumer 14 does not need to wait for the product to be shipped to his or her place of business or home but may immediately acquire the selected product. Moreover, the product supplier need not warehouse or stock the item. Accordingly, the exchange platform 10 (e.g., online store, private electronic communication system) provides an efficient means of delivering products to end-users without the cost of manufacturing, stocking and delivering the product to the consumer 14 resulting in a lower cost to the consumer, higher profit margin for the designer, less working capital requirement and less risk.

Other uses and benefits are also contemplated in relation to the various aspects discussed here. By way of example and not limitation, the electronic exchange platform 10 may provide the basis for a just-in-time inventory control method for a business. Instead of stocking a plurality of parts in inventory, the business may three-dimensionally print the product when inventory is low. Accordingly, the business may stock the raw materials instead of the finished products thereby saving space, delivery costs and other costs associated with stocking a number of products which would be more expensive than stocking only the raw materials.

The electronic exchange platform 10 can also be used to supply replacement parts for equipment. Designers 12 may upload electronic files related to common wear parts or parts that are prone to break to the electronic exchange platform 10. Consumers 14 may download the electronic files of the parts and print the part on a 3-D printer.

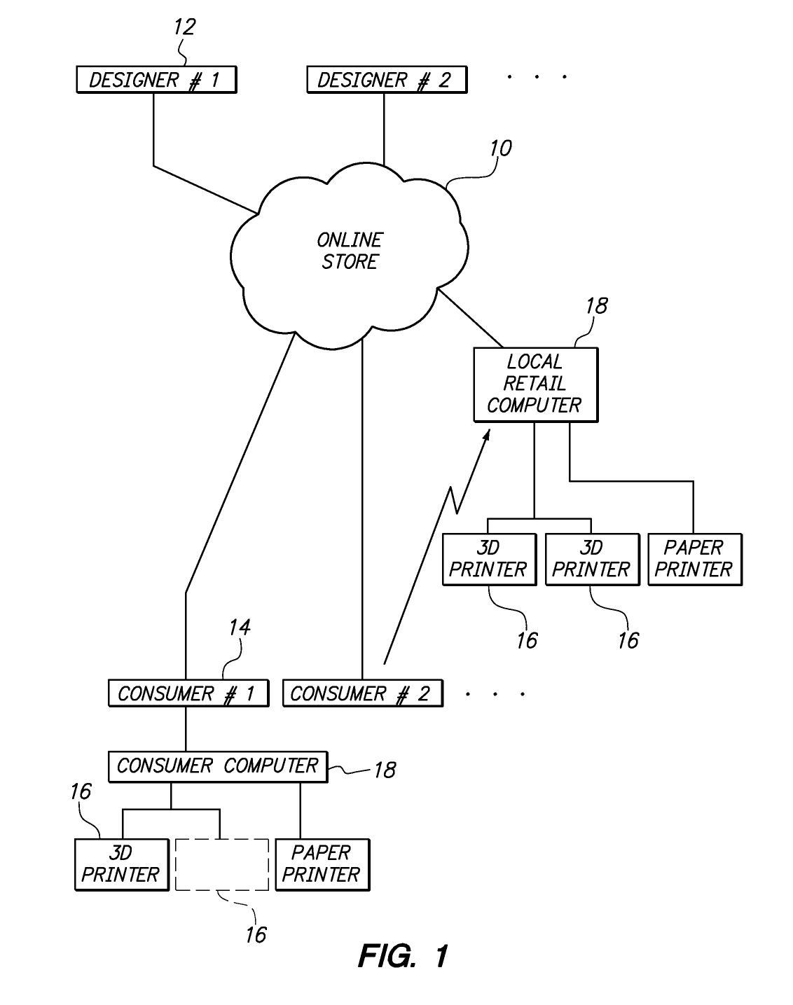

Referring now to FIG. 1, the exchange platform 10 is shown. The exchange platform 10 may be an online store accessible via the World Wide Web or the Internet. Alternatively, the exchange platform 10 may be a private communication system accessible by designers 12 and consumers 14. For example, the private communication system may be a program downloaded onto the consumer's computer or a computer integrated into the 3D printer that establishes a communication link to the online store's electronic portal. For the purpose of simplicity, the exchange platform 10 will be discussed in relation to an online store that can be accessed by designers 12 and consumers 14, as shown in FIG. 1. However, the various aspects discussed in relation to the online store may also be applied to the private communication system.

Designers 12 provide electronic files that are uploaded to the online store 10. The electronic files may be downloaded by the consumers 14 and used to drive a 3-D printer 16. The 3-D printer 16 is a machine that may utilize a manufacturing process which makes a three-dimensional solid object from a digital model comprised of the electronic files. By way of example and not limitation, the manufacturing process may be an additive manufacturing process in which layers are added on top of each other until the three-dimensional solid object is obtained. The additive manufacturing process may include but is not limited to the selective laser sintering, direct metal laser sintering, fused deposition modeling, stereolithography, laminated object manufacturing, electron beam melting, powdered bed and inkjet head 3-D printing. Other processes are also contemplated that are known in the art or developed in the future. Moreover, the manufacturing process may utilize other technologies that are known in the art or developed in the future for making a three-dimensional solid object from the digital model. It is also contemplated that the manufacturing processes may be a subtractive manufacturing process such as machining and milling.

The designers 12 provide the digital model in the form of one or more electronic files. These electronic files are uploaded to the online store 10 for subsequent viewing, purchasing and downloading by consumers 14. The electronic files may be compatible with the manufacturing process for making a three-dimensional solid object from the digital model. For example, the electronic files may be compatible with a 3-D printer 16. In addition to the electronic files corresponding to the digital model, the designer 12 may also upload an instruction set (e.g. document, assembly manual, photographs, illustrations, etc.) that the consumer 14 may print to paper for later reference when 3-D printing and assembling two or more component parts, if necessary.

By way of example and not limitation, the designer 12 may upload electronic files for a rubber stamp. The rubberstamp may have two components, namely, a rubber component with a design on its bottom surface and a rigid handle that is attached to the top side of the rubber component. In this example, the designer 12 may upload two different electronic files. The first electronic file may be for the rubber component. The underside surface of the rubber component may have a stock message (e.g. DRAFT) or customized message (e.g. personal name). The consumer 14 may select the appropriate first electronic file or program the customized message through the online store 10 to generate the first electronic file with the customized message. Alternatively, the instruction set may provide information on how to customize the message after download. The second electronic file may be for the rigid handle. The designer 12 may provide an instruction set which specifies the type of material to feed through the 3-D printer 16 for the rubber component and the rigid handle. The instruction set may also provide assembly instructions for the rubber component and the rigid handle.

The online store 10 receives the electronic files and instruction set for a plurality of three-dimensional printable products. The online store 10 displays these products to consumer 14 who can select, print and assemble the products, if necessary at the consumer's location. No physical delivery to the consumer 14 of the product is required. Rather, the consumer 14 downloads and prints the desired product(s) on a 3-D printer 16 and, if necessary, assembles the component printed parts. The online store 10 may display product reviews from past consumers 14 regarding quality, product review and other factors that might be relevant to consumers 14.

The consumer 14 after selecting the product from the online store 10, downloads the electronic files, and if any, an instruction set to the consumer's computer 18. The consumer 14 prints the three-dimensional objects from the electronic files on his/her 3-D printer 16. If the product requires one or more different types of materials, then the consumer 14 must change out the raw material for the 3-D printer 16 or utilize two or more 3-D printers 16 that can accommodate the specific types of materials dictated by the designer 12. The consumer 14 may print out the electronic files in three-dimensional form on the 3-D printers 16. If more than one component part is printed and needs assembly, the consumer 14 may follow the instruction set to assemble the component parts together.

In the event that the consumer 14 does not have a 3-D printer 16, the consumer 14 may order the 3-D printable product from a retail establishment that has the necessary equipment (e.g. 3-D printer, raw materials, etc.) to print the three-dimensional printable product. Such retail establishment may be at a local retail outlet so that the product does not have to be shipped to the consumer 14. Rather, the consumer 14 may order the product(s) online for pick up at the local retail establishment.

The local retail establishment may download, print, and if needed, assemble the component parts of the printable product for the consumer 14 or the consumer 14 may merely pick up the loose component parts and assemble the product at home.

The exchange platform 10 also supports a just-in-time inventory control methodology. A business may stock a plurality of items needed to run the business. When inventory is low on one or more of the items, the business may simply print a sufficient quantity of items to restock the items for use.

More particularly, the business may stock various items in inventory. These items may generically be referred to as item number 1, 2, 3-n. The business may maintain a certain number of items 1, 2, 3-n for use by employees in the business day-to-day operation. Similarly, a home may stock various items in inventory. These items may also generically be referred to as items A, B, C-n. The home may maintain a certain number of items A, B, C-n for use by the household in the daily operation of the household. Moreover, the business or home may also maintain a certain level of raw materials for use in one or more 3-D printers 16. The raw materials may include but are not limited to plastic, rubber, metal, alloy metal, thermoplastics, eutectic metals, paper, foil, plastic film, titanium alloys, plaster and/or colored plaster. These raw materials will be used to replenish inventory supplies when low by printing the required items 1, 2, 3-n or A, B, C-n. The home or business may also have one or more 3-D printers 16 or additive manufacturing machines that utilize one or more of the raw materials listed above or for which an additive manufacturing machine is developed.

In the daily operation of a home or business, inventory items are constantly being depleted. When the inventory items are low, the home or business may print additional items with the 3-D printer 16 or additive manufacturing machines utilizing the appropriate raw material to restock inventory of the home or business. By printing the items low on inventory to restock inventory, the business or home can resupply its inventory just-in-time without having to allow for transit time of products when determining whether a particular product is low in inventory. For example, if a certain product typically held in inventory takes approximately two (2) weeks to obtain after placing an order, the business or home must have at least two (2) weeks' worth of supply of that product, if not more before placing the order. Otherwise, the business or home will deplete its stock of inventory for that product before the new shipment arrives. By eliminating the transportation time, the inventory for such product can be renewed or increased just before running out of such product by printing these products into inventory. In this manner, the working capital to maintain the inventory is greatly reduced. Also, if suppliers are low on inventory or out of stock of a particular item, the business or home may need to look for alternatives for use in lieu of the original desired product. With the just in time method described herein, inventory can be replenished without being dependent on the stock of the supplier.

A designer 12 may upload one or more electronic files and an instruction set. By way of example and not limitation, the designer 12 may upload a first electronic file, a second file and the third electronic file and one instruction set. The first electronic file may be for a first 3-D printer 16 that prints a first object with a first raw material. The second electronic file may be for a second 3-D printer 16 that prints a second object with a second raw material. The third electronic file may be for a third 3-D printer 16 that prints a third object with the third raw material. The instruction set may be an electronic document that provides a manual or instruction set for assembling or using the first object, the second object and the third object together. The designer 12 may also upload an assembled view of the first, second and third objects representing the end product to be printed. This information may be uploaded to the online store 10 for later viewing and downloading by the consumer 14.

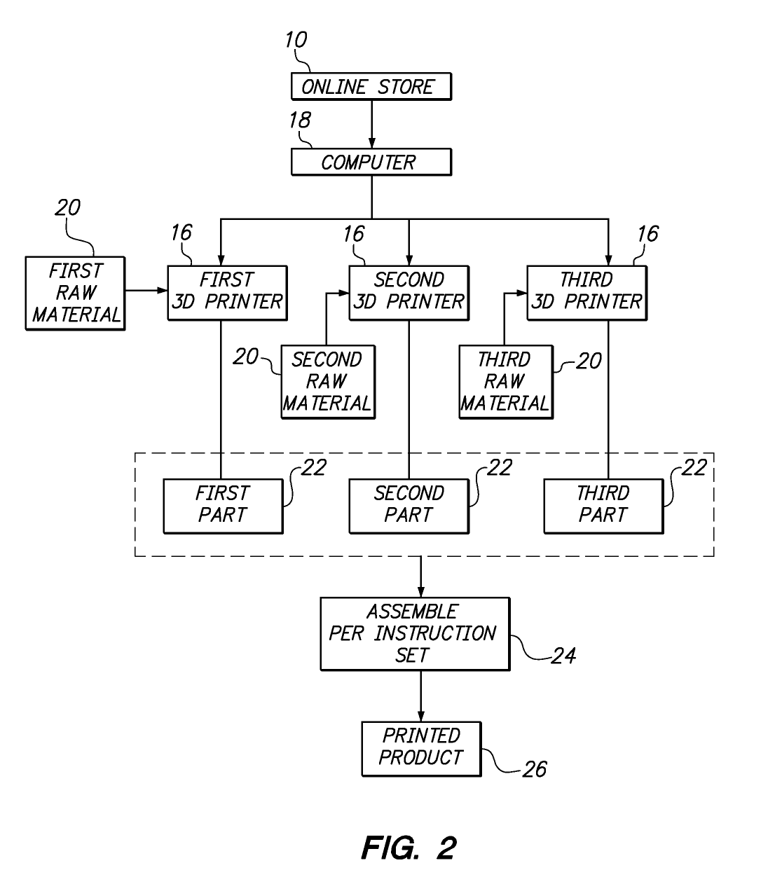

Referring now to FIG. 2, the consumer 14 or a local retail establishment can download the electronic files from the online store 10 to a computer 18 which drives one or more 3-D printers 16. The computer 18 may be integrated into the 3D printer. In this instance, the electronic files may be downloaded directly onto the computer of the 3D printer. Raw materials 20 may be loaded into the corresponding 3-D printers. The 3-D printer 16 can print the component part(s) of the printable product. If necessary, the printed component parts 22 can be assembled 24 so as to produce the printed product 26.

A plurality of designers 12 may upload a plurality of one or more electronic files and corresponding instruction sets to the online store 10. The online store 10 displays the assembled view to the consumer 14. By way of example and not limitation, the online store 10 may organize the various products uploaded by the designers 12 by category. For example, a stapler may be categorized under staplers or paper fasteners, then under the generic term office supplies. When the consumer 14 clicks through various links to arrive at one particular printable stapler, the online store 10 may present other competing printable staplers to the consumer 14. The list of printable staplers may be ranked by price, ease of assembly, quality, necessary 3-D printers and raw materials, customer feedback, and other factors relevant to a consumer's 14 decision.

The consumer 14 may view the online store 10 through the Internet or a web browser. The online store 10 presents a search means (i.e. searchable text field or clickable categories) so that the consumer 14 may find relevant printable products for purchase. Once the consumer 14 finds a product for purchase, the consumer 14 may purchase the electronic files and the instruction set through the online store 10. The consumer 14 may print the various component parts with the corresponding 3-D printers 16 utilizing the appropriate raw material. Once all parts are printed, the consumer 14 may assemble the printed parts together utilizing the instruction set. In this manner, the consumer 14 need not wait until an Internet retailer ships the product and a transportation company delivers the product to the consumer 14. Rather, the consumer 14 may enjoy the printed product upon completion of printing, and if necessary, assembly.

If the consumer 14 does not have all of the necessary 3-D printers 16 and corresponding raw materials or the ability to assemble the component parts that make up the printable product, then the consumer 14 may ask the local retail establishment to print and assemble the printable product for later pickup by the consumer 14.

The above process of selling printable products on an online store 10 can be useful for selling a variety of printable products. By way of example and not limitation, the printable product may be an electronic circuit board. The first component part of the electronic circuit board may be an underlying rigid or flexible flat sheet which supports the electronic circuit. The first component part may be printed on a first 3-D printer 16 that prints the underlying rigid or flexible flat sheet. The flat sheet may have a plurality of holes which will later be used to mount electrical components such as capacitors, resistors, etc. This flexible or rigid flat sheet may be inserted into a second 3-D printer 16 which adheres and prints an electrically conductive material on one or both sides of the flat sheet. The electrically conductive material may be formed in thin strips and begin from one hole of the rigid or flexible flat sheet and terminate at a second hole thereof. The consumer 14 may solder the electrical components to the electronic circuit board during the assembly stage.

The above process of selling printable products on an online store 10 can also be useful for repairing machinery or repairing one of the component parts of the printable products. By way of example and not limitation, if the printable product contains two or more printable parts and one of the printable parts breaks, the consumer 14 only needs to print the broken printable part and replace the same on the product. The consumer 14 does not need to purchase the entire product or print all of the component parts of the printable product. Also, for equipment, businesses that utilize machinery can replace high wear parts and parts prone to breaking with the exchange platform. Instead of having to order a replacement part from a supplier, the business can purchase corresponding electronic files, download and print the replacement part when needed. Accordingly, the various aspects disclosed herein save the consumer 14 money by having to purchase less than the entire product to fix the product or machinery. Also, the various aspects disclosed herein save time and money in that machinery can stay running for a longer period of time since the replacement part can be printed immediately without having to find the part or have the manufacturer manufacture a replacement part. The replacement part is immediately printed for use in the machinery.

The online store 10 may also feature printable products that exceed the size requirement (i.e., build envelope) of current 3-D printers 16. By way of example and not limitation, if current build envelope of 3-D printers 16 is 1′×1′×1′, the online store 10 may feature printable products that are greater than the 1′×1′×1′ cubic size. To do so, multiple smaller part components may be printed and connected to each other with dowels. By way of example and not limitation, a first part may define a first surface which mates with a mating first surface of a second part. The mating first surfaces of the first and second parts may have matching holes in both size and position. To connect the first and second parts together a plurality of dowels may be printed. The dowel may have an outer diameter which is slightly larger than an inner diameter of the matching holes. The dowels are inserted into respective holes in the first surfaces of the first and second parts and used to attach the two parts together by a friction fit. An adhesive may also be used to adhere the dowel in the holes. This allows one to create a substantially larger product than which is allowed through a small format 3-D printer 16.

The three dimensional solid object discussed herein are solid objects having three dimensions and not directed to stereoscopic 3D imaging or 2 dimensional pieces that might have a three dimensional optical illusion. A few examples of the three dimensional products were discussed herein. The electronic files for the types of three dimensional products are not limited to the specific examples provided herein but are discussed for the purposes of example and not limitation. Other types of product include any type of injection molded part, toys such as LEGO, electrical outlet wall plates, and other products. Moreover, the printed products may contain a number of parts that are later assembly. However, it is also contemplated that the printed product may contain a plurality of moving parts that are printed together in a single print operation.

The electronic files uploaded by the designer and downloaded by the consumer to print 3 dimensional objects and/or the 3D printer may have a digital rights management system (“DRMS”) incorporated into the electronic files and/or the 3D printers that limit use of the electronic files for a limited period of time and/or for a limited number of uses. By way of example and not limitation, the DRMS may enable use of the electronic files for one day, one week, one month, one year or any other time period. Alternatively or additionally, the DRMS may enable use of the electronic files for a specific number of uses. By way of example, the DRMS may enable use of the electronic files for a single use. The consumer can print only one printed product. The DRMS may enable use of the electronic files for 5 uses, 10 uses, etc. The consumer can also print out unlimited rights so that the consumer may utilize the electronic files for a limited duration of time but for an unlimited or limited number of uses or a limited number of uses but for a limited or unlimited duration of time.

The unique and novel DRM scheme could be implemented, by way of example and not limitation, so that the transmitted instructions are not a 3D model, but instead the raw tool path instructions for the printer itself. In this instance, the transmitted file would be unreadable by conventional 3D rendering software. The transmitted file provides coordinate instructions for the printer's toolhead. In other words, the transmitted file would contain instructions only for the 3D printer itself and would not be backwards viewable on a computer. By this method and system, the designer's copyright in the transmitted file, instruction set or 3D model would be given a level of protection so that the end user could not or it would make it significantly more difficult or impossible to modify the transmitted file in a usable form. Another advantage with the DRM scheme is that the unique tool path identifiers can be placed within the tool path instructions for reasons of tracking any given digital file back to the source. By way of example and not limitation, an insignificant marker (e.g., squiggly line) could be placed somewhere in the tool path instructions. The marker is insignificant in that it does not affect the function of the printed part. This squiggly line would be hard or impossible to detect. The tool path instructions can be used to track any given digital file back to its originator or source.

The above description is given by way of example, and not limitation. Given the above disclosure, one skilled in the art could devise variations that are within the scope and spirit of the invention disclosed herein, including various ways of three-dimensionally printing the desired products. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A method for facilitating exchange of electronic files of three-dimensional printable products, the method comprising the steps of:
receiving at least one electronic file from each of a plurality of suppliers of electronic files of three-dimensional printable products;
displaying the three-dimensional printable products to consumers of the three-dimensional printable products;
receiving selections of the displayed three-dimensional printable products from consumers; and
transmitting the corresponding electronic files of the received selection of three-dimensional printable products to the consumers.

2. The method of claim 1 further comprising the step of transmitting instruction sets to the consumers for the received selections of three-dimensional printable products.

3. The method of claim 1 wherein the three-dimensional printable products are each smaller than 1′×1′×1′.

4. The method of claim 1 wherein the transmitting step comprises the step of transmitting to one of the consumers a plurality of electronic files which after being printed may be assembled to make up the three-dimensional printable products.

5. The method of claim 1 wherein the three-dimensional printable products are displayed by category to the consumer.

6. The method of claim 1 further comprising the step of displaying a rank of the printable product in relation to at least one of quality of electronic files, past consumer ranking, compatible raw materials, and compatible 3D printers to the consumers.

7. A just-in-time inventory control method, the method comprising the steps of:
tracking inventory for a plurality of three-dimensional printable products;
printing one or more three-dimensional printable products when the tracking step indicates a low quantity of the one or more three-dimensional printable products.

8. The method of claim 9 further comprising the step of accessing an online store of electronic files of three-dimensional printable products.

9. A digital rights management method comprising the steps of:
providing a tool path instruction into a file to be transmitted to an end user for printing a 3D object;
incorporating an insignificant marker in the tool path instruction; and
transmitting the tool path instruction to the end user.

10. The method of claim 9 wherein the marker is a unique tool path instruction that does not affect functional or aesthetic value of the 3D object being printed.
